(19) United States
(12) Patent Application Publication
(10) Pub. No.: US 2024/0186593 A1
(43) Pub. Date: Jun. 6, 2024

(54) REMOTE MONITORING SYSTEM AND MAINTENANCE METHOD FOR ITEM AND/OR BATTERY

(71) Applicant: NGK INSULATORS, LTD., Nagoya-City (JP)

(72) Inventors: Chiori SUZUKI, Nagoya-City (JP); Iwao OHWADA, Nagoya-City (JP); Takaaki KOIZUMI, Tajimi-City (JP)

(73) Assignee: NGK INSULATORS, LTD., Nagoya-City (JP)

(21) Appl. No.: 18/442,280

(22) Filed: Feb. 15, 2024

Related U.S. Application Data
(63) Continuation of application No. PCT/JP2022/030882, filed on Aug. 15, 2022.

(30) Foreign Application Priority Data
Aug. 19, 2021 (JP) 2021-134256

(51) Int. Cl. H01M 10/42; H01M 10/0525; H01M 10/48

(52) U.S. Cl. CPC H01M 10/425; H01M 10/0525; H01M 10/486; H01M 10/488; H01M 2010/4278

(57) ABSTRACT

There is provided a remote monitoring system for remotely monitoring the state of an item and/or battery, including a lithium-ion secondary battery capable of wireless power transfer, a sensor that detects the state of the item and/or lithium-ion secondary battery to acquire status information, a wireless communication module connected to the lithium-ion secondary battery and the sensor, the wireless communication module including a transmission unit that transmits the status information to a remote server, and a reception unit that receives a warning signal transmitted from the remote server when the status information is out of a normal range, and means for issuing an alert appealing to the five senses in response to the reception of the warning signal.

### CROSS-REFERENCE TO RELATED APPLICATIONS

This application is a continuation application of PCT/JP2022/030882 filed Aug. 15, 2022, which claims priority to Japanese Patent Application No. 2021-134256 filed Aug. 19, 2021, the entire contents all of which are incorporated herein by reference.

### BACKGROUND OF THE INVENTION

### 1. Field of the Invention

The present invention relates to a remote monitoring system and a maintenance method for an item and/or a battery.

### 2. Description of the Related Art

There are known wireless terminals which are easy to collect data from and drive wirelessly, and which can be used for long periods without battery replacements. For example, Patent Literature 1 (JP6819262B) discloses a wireless terminal including a radio, a power source, an application device, and a power controller, and describes that the power source includes a power-generating element and a secondary power storage device capable of storing power generated by the power-generating element. The power controller carries out control causing power to be supplied to the radio from mainly the secondary power storage device during a communication period, and causing power from the power-generating element to be stored in the secondary power storage device during a non-communication period. The literature describes that the secondary power storage device may be a secondary battery or an electric double layer capacitor.

On the other hand, with the proliferation of IoT devices, small and thin lithium-ion secondary batteries have been attracting attention in recent years. For example, Patent Literature 2 (WO2019/221140) discloses a lithium-ion secondary battery including a positive electrode layer composed of a lithium composite oxide sintered body, a negative electrode layer composed of a titanium-containing sintered body, a ceramic separator, and an electrolyte, the lithium-ion secondary battery being said to have high discharge capacity and excellent charge-discharge cycle performance. As such a secondary battery, the chip-type ceramic secondary battery “EnerCera”® made by NGK Insulators, Ltd. is commercially available, and is being considered for use in various applications. Secondary batteries of this type have the advantage of being chargeable by wireless power transfer.

### CITATION LIST

### Patent Literature

Patent Literature 1: JP6819262B
Patent Literature 2: WO2019/221140

### SUMMARY OF THE INVENTION

By mounting a chip-type ceramic secondary battery as described above in an IoT device (for example, a sensor tag) attached to an item (for example, cargo), it is possible to attain an IoT device that can be used for a long period by charging. However, since battery information for operating the IoT device cannot be managed, status information indicating that the battery level has decreased, the battery is about to break, or the battery is broken cannot be obtained, and as a result, a sudden shutdown of device function (for example, sensor function) could occur. Similarly, a sudden inability to acquire status information about an item (for example, cargo) to be acquired by the device (for example, a sensor tag) could also occur.

The inventors have recently discovered that by using a lithium-ion secondary battery capable of wireless power transfer and adopting a configuration to issue an alert appealing to the five senses when status information about an item and/or battery is out of a normal range, it is possible to provide a remote monitoring system capable of notifying a nearby person of abnormality in the item and/or battery beforehand or immediately. Additionally, by detecting abnormality in the item and/or battery through the remote monitoring system and taking measures to return the item and/or battery to a normal state, damage due to an unexpected and sudden malfunction (such as battery depletion, battery or device failure, or data loss, for example) can be avoided or minimized.

Consequently, one objective of the present invention is to provide a remote monitoring system capable of notifying a nearby person of abnormality in an item and/or battery beforehand or immediately. Another objective of the present invention is to provide a maintenance method for an item and/or battery capable of avoiding or minimizing damage due to an unexpected and sudden malfunction (such as battery depletion, battery or device failure, or data loss, for example).

The present invention provides the following aspects.

### [Aspect 1]

A remote monitoring system for remotely monitoring the state of an item and/or a battery, the remote monitoring system comprising:
a lithium-ion secondary battery capable of wireless power transfer;
a sensor that detects the state of the item and/or the lithium-ion secondary battery to acquire status information;
a wireless communication module connected to the lithium-ion secondary battery and the sensor, the wireless communication module comprising a transmission unit that transmits the status information to a remote server, and a reception unit that receives a warning signal transmitted from the remote server when the status information is out of a normal range; and
means for issuing an alert appealing to the five senses in response to the reception of the warning signal.

### [Aspect 2]

The remote monitoring system according to aspect 1, wherein the remote monitoring system further comprises a power transfer receiver capable of charging the secondary battery by wireless power transfer.

### [Aspect 3]

The remote monitoring system according to aspect 1 or 2, wherein the status information includes information pertaining to the state of the lithium-ion secondary battery, and when charging, repair, or replacement of the lithium-ion secondary battery is determined to be necessary on the basis of the information, the warning signal is transmitted and received.

### [Aspect 4]

The remote monitoring system according to aspect 3, wherein the information pertaining to the state of the lithium-ion secondary battery includes at least one selected from the group consisting of the voltage, resistance, and temperature of the lithium-ion secondary battery.

### [Aspect 5]

The remote monitoring system according to any one of aspects 1 to 4, wherein the remote monitoring system further includes a remote server, the remote server comprising:
a server reception unit that receives the status information;
a server determination unit that determines, on the basis of the status information, whether or not any action is required with respect to the item and/or the lithium-ion secondary battery; and
a server transmission unit that transmits the warning signal when it is determined by the server determination unit that the action is required.

### [Aspect 6]

The remote monitoring system according to aspect 5,
wherein the remote server further comprises a server storage unit that store data necessary for determining normality and abnormality in relation to the item and/or the lithium-ion secondary battery, and
wherein the server determination unit compares the status information with the data from the server storage unit to determine whether or not the action is required.

### [Aspect 7]

The remote monitoring system according to aspect 6,
wherein the information pertaining to the state of the lithium-ion secondary battery includes the voltage and/or resistance of the lithium-ion secondary battery,
wherein the data in the server storage unit includes correlation data between the state of charge and the voltage and/or resistance pertaining to the lithium-ion secondary battery, and
wherein the server determination unit determines that the action is required when the information pertaining to the state of the lithium-ion secondary battery is out of a normal range in comparison to the correlation data from the server storage unit.

### [Aspect 8]

The remote monitoring system according to aspect 6,
wherein the information pertaining to the state of the lithium-ion secondary battery includes the voltage and/or resistance and the temperature of the lithium-ion secondary battery,
wherein the data in the server storage unit includes correlation data between the state of charge and the voltage and/or resistance pertaining to the lithium-ion secondary battery at various temperatures, and
wherein the server determination unit determines that the action is required when the information pertaining to the state of the lithium-ion secondary battery is out of a normal range in comparison to the correlation data from the server storage unit corresponding to the temperature.

### [Aspect 9]

The remote monitoring system according to any one of aspects 6 to 8, wherein the server storage unit accumulates the status information that the server reception unit receives, thereby enhancing the data necessary for determining normality and abnormality.

### [Aspect 10]

The remote monitoring system according to any one of aspects 1 to 9, wherein communication between the wireless communication module and the remote server is performed by Bluetooth Low Energy (BLE) or low-power wide-area (LPWA) communication.

### [Aspect 11]

The remote monitoring system according to any one of aspects 1 to 10, wherein the lithium-ion secondary battery is a secondary battery comprising a positive electrode plate which is a lithium composite oxide sintered plate, a negative electrode layer which is composed of a lithium titanate sintered plate or which contains carbon, a separator disposed between the positive electrode plate and the negative electrode layer, and an electrolyte.

### [Aspect 12]

The remote monitoring system according to aspect 11, wherein the lithium composite oxide composing the positive electrode plate is lithium cobaltate.

### [Aspect 13]

The remote monitoring system according to aspect 11 or 12, wherein the negative electrode layer is composed of a lithium titanate sintered plate.

### [Aspect 14]

The remote monitoring system according to any one of aspects 1 to 13, wherein the lithium-ion secondary battery is the chip-type ceramic secondary battery “EnerCera”®.

### [Aspect 15]

A maintenance method for an item and/or a battery, the maintenance method comprising the steps of:
perceiving abnormality of the item and/or the lithium-ion secondary battery through an alert appealing to the five senses via the remote monitoring system according to any one of aspects 1 to 14; and
taking measures for returning the item and/or the lithium-ion secondary battery to a normal state.

### [Aspect 16]

The maintenance method for an item and/or a battery according to aspect 15,
wherein the status information includes information pertaining to the state of the lithium-ion secondary battery, and in the remote monitoring system, when charging, repair, or replacement of the lithium-ion secondary battery is determined to be necessary on the basis of the information, the warning signal is transmitted and received, and
wherein the measures for returning the lithium-ion secondary battery to the normal state include moving the lithium-ion secondary battery to a location where wireless power transfer is available and/or repairing or replacing the lithium-ion secondary battery.

### BRIEF DESCRIPTION OF THE DRAWINGS

FIG. 1 is a diagram illustrating an example of a remote monitoring system of the present invention.

FIG. 2 is a flowchart for explaining an example of processing content of a remote server in the remote monitoring system of the present invention.

FIG. 3 illustrates an example of temperature and humidity changes over time for a product in transit, monitored by the remote monitoring system.

### DETAILED DESCRIPTION OF THE INVENTION

In the following description, functions may be described using the expression “yyy unit”, but the description of each function is an example, and multiple functions may be combined into a single function, or a single function may be divided into multiple functions.

### Remote Monitoring System

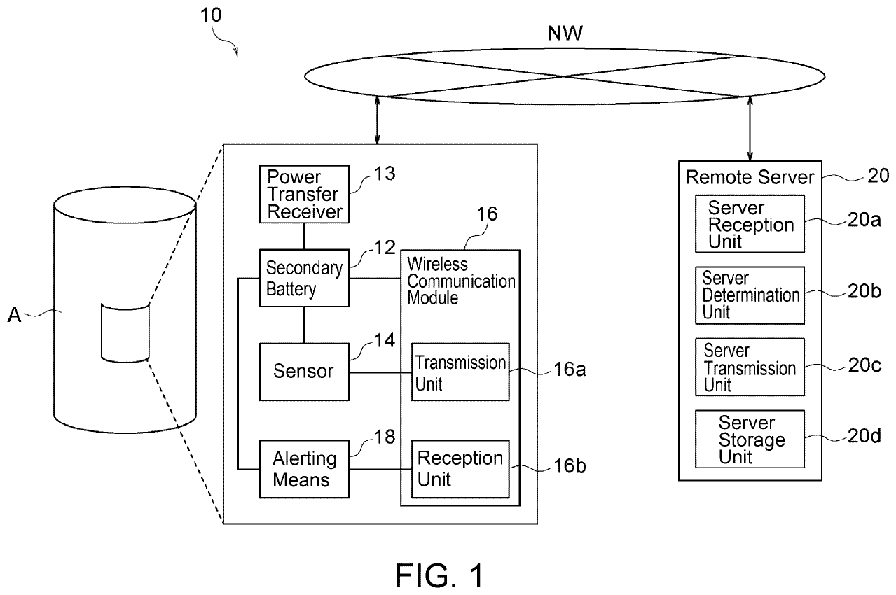

FIG. 1 illustrates one form of a remote monitoring system for remotely monitoring the state of an item and/or battery. The remote monitoring system 10 illustrated in FIG. 1 includes a secondary battery 12, a sensor 14, a wireless communication module 16, and alerting means 18. The secondary battery 12 is a lithium-ion secondary battery capable of wireless power transfer. The sensor 14 detects the state of an item A and/or the secondary battery 12 to acquire status information. The wireless communication module 16 is connected (directly or indirectly) to the secondary battery 12 and the sensor 14, and includes a transmission unit 16a and a reception unit 16b. The transmission unit 16a transmits status information to a remote server 20, whereas the reception unit 16b receives warning information transmitted from the remote server 20 when the status information is out of a normal range. The alerting means 18 issues an alert appealing to the five senses (at least one selected from among sight, hearing, touch, smell, and taste) in response to the reception of a warning signal from the wireless communication module 16. In this way, by using the lithium-ion secondary battery 12 capable of wireless power transfer and adopting a configuration to issue an alert appealing to the five senses when status information about the item A and/or battery 12 is out of a normal range, it is possible to provide the remote monitoring system 10 capable of notifying a nearby person of abnormality in the item A and/or secondary battery 12 beforehand or immediately. Additionally, by detecting abnormality in the item A and/or battery 12 through the remote monitoring system 10 and taking measures to return the item A and/or battery 12 to a normal state, damage due to an unexpected and sudden malfunction (such as battery depletion, battery or device failure, or data loss, for example) can be avoided or minimized.

The secondary battery 12 is a lithium-ion secondary battery capable of wireless power transfer. The lithium secondary battery is not particularly limited insofar as charging is possible even with weak power obtained through wireless power transfer. A preferred lithium-ion secondary battery 12 includes a positive electrode plate which is a lithium composite oxide sintered plate, a negative electrode layer which is composed of a lithium titanate sintered plate or which contains carbon, a separator disposed between the positive electrode plate and the negative electrode layer, and an electrolyte. The lithium composite oxide composing the positive electrode plate is preferably lithium cobaltate. The negative electrode layer is preferably composed of a lithium titanate sintered plate. The electrolyte may be an electrolytic solution or a solid-state electrolyte. In other words, the secondary battery 12 may be a liquid-type battery or an all-solid-state battery. A preferred product example of the lithium-ion secondary battery 12 capable of wireless power transfer is the chip-type ceramic secondary battery “EnerCera”@ made by NGK Insulators, Ltd. The EnerCera product family has two types: “EnerCera Pouch”, which is ultra-thin with a thickness of 0.45 mm and bend-resistant for card mounting; and “EnerCera Coin”, which is coin-shaped with a thickness of 1-2 mm for circuit board mounting. EnerCera Pouch product examples (product numbers) include EC382504P-P, EC382204P-C, EC382704P-C, and EC382704P-H, ET271704P-H, and the like. EnerCera Coin product examples (product numbers) include ET2016C-R, ET1210C-H, ET2016C-H, ET920C, ET1616C, and the like. In particular, a preferred secondary battery 12 such as EnerCera is also capable of sensing battery information (battery level information) via voltage and resistance values, which allows for battery self-diagnostics. Therefore, it is possible to simultaneously check whether the battery is working properly and also analyze the degree of battery degradation in the use environment from the information collected (which can then be fed back to the battery development department). Also, a preferred secondary battery 12 such as EnerCera can carry a large current and does not require a capacitor, and therefore is also advantageous in view of cost, circuit design, and space. Furthermore, a preferred secondary battery 12 such as EnerCera can be charged by wireless power transfer or photovoltaic (PV) power generation, eliminating the need for a power-generating element.

The secondary battery 12 may receive wireless power transfer through a power transfer receiver 13. Consequently, the remote monitoring system 10 preferably further includes the power transfer receiver 13 capable of charging the secondary battery 12 by wireless power transfer. The power transfer receiver 13 may be built into the secondary battery 12, or the power transfer receiver 13 may be externally attached to the secondary battery 12. The power transfer receiver 13 is not particularly limited, and any publicly known or commercially available wireless power transfer receiver may be used.

The sensor 14 acquires detects the state of an item A and/or the secondary battery 12 to acquire status information. Preferably, the status information includes information pertaining to the state of the secondary battery 12, and when charging, repair, or replacement of the secondary battery 12 is determined to be necessary on the basis of the information, a warning signal is transmitted and received. In this case, the information pertaining to the state of the secondary battery 12 preferably includes at least one selected from the group consisting of the voltage, resistance, and temperature of the secondary battery 12.

Examples of the sensor 14 include a voltage sensor, a resistance sensor, a temperature sensor, a humidity sensor, a barometric pressure sensor, an oxygen concentration sensor, a nitrogen concentration sensor, a carbon dioxide gas sensor, a vibration sensor, an acceleration sensor, a geomagnetic sensor, and the like.

The wireless communication module 16 includes the transmission unit 16a and the reception unit 16b. The transmission unit 16a transmits status information to a remote server 20, whereas the reception unit 16b receives warning information transmitted from the remote server 20 when the status information is out of a normal range. The wireless communication module 16 may also include a Global Positioning System (GPS) function, and thereby be capable of ascertaining position information. In other words, the wireless communication module 16 may further include a GPS module.

The alerting means 18 issues an alert appealing to the five senses in response to the reception of a warning signal from the wireless communication module 16. Examples of visual alerts include the display of an image or text, a change of color, and the like. Examples of auditory alerts include the generation of a warning tone, the generation of a voice message, and the like. Examples of tactile alerts include oscillation (vibration) and the like. Examples of olfactory alerts include the generation of a characteristic scent and the like. Consequently, examples of the alerting means 18 include a display or other display device, a buzzer, a speaker, vibration, scent, and the like. The display device may display information about the item A (for example, cargo) and the level of the secondary battery 12. The display device may also be in the form of a sensor tag, and in this case, the sensor tag may be a combination of the sensor 14 and the alerting means 18. For example, the sensor tag may continuously display the temperature, and may be configured such that when abnormality such as high or low temperature is detected, the temperature display is shown in a different hue than usual (for example, a change in the background color and/or text color, for example black and white reversal). Also, since the alerting means 18 may be any means allowing a nearby person (such as a user, worker, administrator, or other person who happens to be present, for example) to notice the abnormality, the method of alerting may be via email or the like to an electronic device (for example, a smartphone or mobile PC) carried by the nearby person.

The remote monitoring system 10 may further include the remote server 20. The remote server 20 includes a server reception unit 20a, a server determination unit 20b, and a server transmission unit 20c. The server reception unit 20a receives (typically via a network NW) status information sent from the transmission unit 16a of the wireless communication module 16. The server determination unit 20b determines, on the basis of the received status information, whether or not any action is required with respect to the item A and/or secondary battery 12. The action is typically a measure for returning an abnormal state of the item A and/or battery 12 to a normal state. When it is determined by the server determination unit 20b that such action is required, the server transmission unit 20c transmits a warning signal. As described above, the warning signal is a signal receivable (typically via the network NW) by the reception unit 16b of the wireless communication module 16. Typically, the server determination unit 20b may be a microprocessor device such as a central processing unit (CPU), but may also be another kind of processor device such as a graphics processing unit (GPU). The server determination unit 20b may be single-core, multi-core, or a processor core. The server determination unit 20b may also be a processor device in the broad sense, such as a circuit that is a collection of gate arrays according to a hardware description language that performs some or all processing (for example, a field-programmable gate array (FPGA), a complex programmable logic device (CPLD), or an application-specific integrated circuit (ASIC)).

Preferably, the remote server 20 further includes a server storage unit 20d to store data necessary for determining normality and abnormality in relation to the item A and/or secondary battery 12. In this case, the server determination unit 20b can compare status information with data from the server storage unit 20d to determine whether or not action is required. Typically, the server storage unit 20d may be a non-volatile storage device (for example, an auxiliary storage device), and specifically may be a hard disk drive (HDD), a solid-state drive (SSD), a non-volatile memory express (NVME) drive, or storage-class memory (SCM), for example.

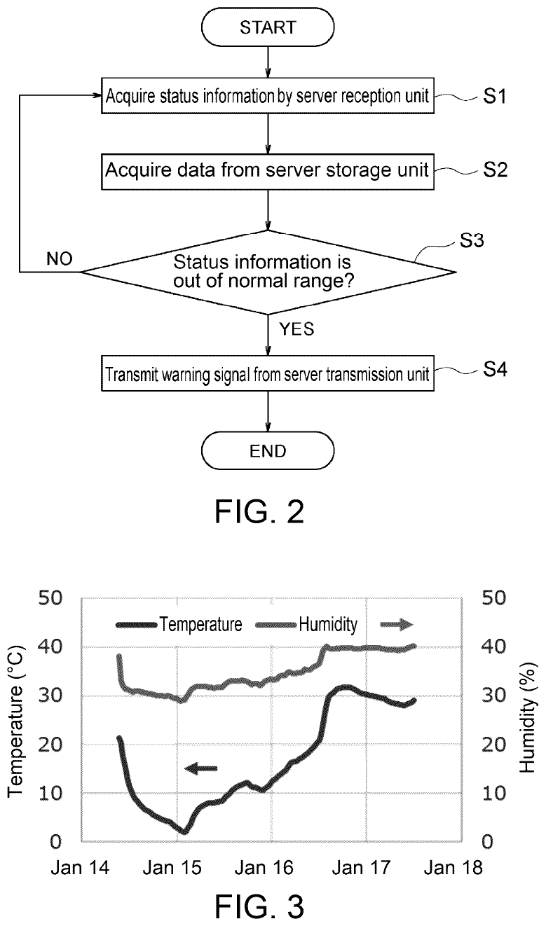

FIG. 2 illustrates an example of processing content in the remote server 20. First, status information is acquired by the server reception unit 20a of the remote server 20 via the network NW (S1). The status information is transmitted from the transmission unit 16a of the wireless communication module 16. If necessary, data necessary for determining normality and abnormality in relation to the item A and/or secondary battery 12 is acquired from the server storage unit 20d (S2). It is determined by the server determination unit 20b (preferably by comparing against data acquired from the server storage unit 20d) whether or not the status information is out of a normal range (S3), and if out of the normal range (S3, YES), a warning signal is transmitted from the server transmission unit 20c (S4). The warning signal is received by the reception unit 16b of the wireless communication module 16 via the network NW. On the other hand, if the status information is not out of the normal range (S3, NO), the flow returns to S1, and S2 and S3 are repeated.

In the case in which the information (status information) pertaining to the secondary battery 12 includes the voltage and/or resistance of the secondary battery 12, the data in the server storage unit 20d preferably includes correlation data between the state of charge (SOC) and the voltage and/or resistance pertaining to the secondary battery 12. In this case, the server determination unit 20b can determine that action is required when the information pertaining to the state of the secondary battery 12 is out of the normal range in comparison to the correlation data from the server storage unit 20d. That is, if there is correlation data between the state of charge (SOC) and the voltage and/or resistance pertaining to the secondary battery 12, the value of the SOC for the value of the voltage or resistance of the secondary battery 12 measured with the sensor 14 can be determined from the correlation data. Consequently, it can be ascertained from the SOC that the battery level of the secondary battery 12 has decreased. As a further consequence, if the server determination unit 20b is set such that a warning signal is issued when the SOC has become equal to or less than a predetermined value, an alert can be issued in a timely manner, before reaching battery depletion or battery or device failure.

The information (status information) pertaining to the state of the secondary battery 12 may include not only the voltage and/or resistance of the secondary battery 12, but also the temperature. In this case, the data in the server storage unit 20d preferably includes correlation data between the state of charge (SOC) and the voltage and/or resistance pertaining to the secondary battery 12 at various temperatures. The relationship between the SOC and the voltage and/or resistance in a secondary battery may also differ to some degree depending on the temperature, and thus by considering the temperature, normality/abnormality of the secondary battery 12 can be determined more accurately. In this form, the server determination unit 20b can determine that action is required when the information pertaining to the state of the secondary battery 12 is out of the normal range in comparison to the correlation data from the server storage unit 20d corresponding to the relevant temperature. For this purpose, it is desirable to provide in advance, and store in the server storage unit 20d, correlation data between the state of charge (SOC) and the voltage and/or resistance pertaining to the secondary battery 12 under various temperature conditions. In so doing, the value of the SOC for the value of the voltage or resistance of the secondary battery 12 measured with the sensor 14 can be determined more accurately from the correlation data. Consequently, it can be ascertained more accurately from the SOC that the battery level of the secondary battery 12 has decreased, and an alert can be issued in a more timely manner.

According to a preferred form of the present invention, the server storage unit 20d accumulates status information that the server reception unit 20a receives, thereby enhancing the data necessary for determining normality and abnormality. For example, data on the use environment and conditions of the secondary battery 12 and battery level data can be combined and accumulated in the server storage unit 20d, and the data accumulated in this way can be analyzed to obtain feedback regarding better ways of using the secondary battery 12. For example, information such as what kinds of use environments and conditions make the secondary battery 12 susceptible to degradation and to what degree can be accumulated according to the type and specifications of the secondary battery 12. Moreover, the information accumulated in this way can be used as the basis for running a simulation of harsh use conditions for a specific secondary battery, whereby accumulated data can be utilized in future battery development.

Communication between the wireless communication module 16 and the remote server 20 may be performed according to any of various communication network schemes and is not particularly limited, but preferably is performed by Bluetooth Low Energy (BLE) or low-power wide-area (LPWA) communication.

### Maintenance Method

By using the remote monitoring system 10 of the present invention, a nearby person can be notified of abnormality in the item A and/or battery 12 beforehand or immediately. Additionally, by detecting abnormality in the item A and/or battery 12 and taking measures to return the item A and/or battery 12 to a normal state, damage due to an unexpected and sudden malfunction (such as battery depletion, battery or device failure, or data loss, for example) can be avoided or minimized. A preferred form of such a maintenance method for an item and/or battery is described below.

A maintenance method according to the present form includes the steps of: perceiving abnormality of the item A and/or secondary battery 12 through an alert appealing to the five senses via the remote monitoring system 10, and taking measures for returning the item A and/or secondary battery 12 to a normal state. That is, an alert appealing to the five senses can cause a person (such as a user, worker, administrator, or other person who happens to be present, for example) in the vicinity of the alerting means 18 to perceive abnormality of the item A and/or secondary battery 12, and appropriate measures for returning the item A and/or secondary battery 12 to a normal state may simply be taken according to the content of the abnormality.

Examples of abnormality in the secondary battery 12 include that the battery level has decreased, and that the battery is about to break or is broken. In the former case, the secondary battery 12 may simply be charged, and in the latter case, the battery may simply be repaired or replaced. Examples of abnormality in the item A include the case in which the temperature or humidity of an item requiring temperature or humidity control (such as food, beverages, alcoholic beverages, drugs, and vaccines, for example) is out of a proper range. In this case, too, measures may simply be taken to return the temperature, humidity, or other conditions to the proper range.

In particular, the status information preferably includes information pertaining to the state of the secondary battery 12. In this case, the remote monitoring system 10 can transmit/receive a warning signal upon determining that charging, repair, or replacement of the secondary battery 12 is necessary based on the above information. In this case, the measures for returning the secondary battery 12 to the normal state include moving the secondary battery 12 to a location where wireless power transfer is available (power transfer spot) and/or repairing or replacing the secondary battery 12. The warning signal from the server transmission unit 20c may also include a warning signal that is distinguishable depending on the abnormality content, and in this case, the alerting means 18 preferably issues an alert urging a move to a power transfer spot and an alert urging repair or replacement of the secondary battery 12 in a distinguishable manner from the standpoint of the five senses. In this case, the secondary battery 12 may simply be moved to a power transfer spot, or the secondary battery 12 may simply be repaired or replaced, depending on the type of alert.

### Uses

Preferred application examples of the remote monitoring system 10 include sensor tags that can be used to check the quality of goods during transport (for example, tags that measure temperature, humidity, and the like and communicate wirelessly). This application example makes it possible to attain safe, secure, and high-quality transportation and inventory management in which the transportation status can be assured with data. The following are examples of the new value that the secondary battery 12 such as EnerCera described above provides in this application example.
Battery replacement is unnecessary, so no waste is generated.
The battery is a secondary battery and thus can be reused many times, reducing sensor tag costs.
The state of cargo can be monitored directly.
The battery can operate down to −40° C. and can also be used for cold chain.

### Example of Remote Monitoring System

A remote monitoring experiment was conducted according to the following implementation details on sensor-tagged transport goods to which the remote monitoring system 10 was applied.
Means of measurement: EnerCera onboard sensor logger
Transport goods: ceramic products (made by NGK Insulators, Ltd.) with above sensor logger attached
Means of transport: truck and airplane
Items measured: temperature, humidity, and time
Measurement location: between factories (from factory A to factory B)
Measurement period: Jan. 14, 2022 to Jan. 18, 2022

FIG. 3 illustrates temperature and humidity changes over time monitored by the remote monitoring system. As illustrated in FIG. 3, the product transport environment from departure from factory A to arrival at factory B is clarified. Furthermore, if lower and/or upper temperature limits or upper and/or lower humidity limits are set in advance in the remote monitoring system, abnormality can be detected immediately. For example, in the data illustrated in FIG. 3, abnormality can be detected as follows.
When the lower temperature limit is set to 5° C., abnormality is detected on January 15.
When the upper temperature limit is set to 30° C., abnormality is detected on January 16.
When the upper humidity limit is set to 40%, abnormality is detected on January 16.

What is claimed is:

1. A remote monitoring system for remotely monitoring the state of a battery, the remote monitoring system comprising:
a lithium-ion secondary battery capable of wireless power transfer;
a sensor that detects the state of the lithium-ion secondary battery to acquire status information;
a wireless communication module connected to the lithium-ion secondary battery and the sensor, the wireless communication module comprising a transmission unit that transmits the status information to a remote server, and a reception unit that receives a warning signal transmitted from the remote server when the status information is out of a normal range; and
means for issuing an alert appealing to the five senses in response to the reception of the warning signal,
wherein the status information includes information pertaining to the state of the lithium-ion secondary battery, and when charging, repair, or replacement of the lithium-ion secondary battery is determined to be necessary on the basis of the information, the warning signal is transmitted and received.

2. The remote monitoring system according to claim 1, wherein the information pertaining to the state of the lithium-ion secondary battery includes at least one selected from the group consisting of the voltage, resistance, and temperature of the lithium-ion secondary battery.

3. The remote monitoring system according to claim 1,
wherein the remote monitoring system further includes a remote server, the remote server comprising:
a server reception unit that receives the status information;
a server determination unit that determines, on the basis of the status information, whether or not any action is required with respect to the lithium-ion secondary battery; and
a server transmission unit that transmits the warning signal when it is determined by the server determination unit that the action is required.

4. The remote monitoring system according to claim 3,
wherein the remote server further comprises a server storage unit that store data necessary for determining normality and abnormality in relation to the lithium-ion secondary battery, and
wherein the server determination unit compares the status information with the data from the server storage unit to determine whether or not the action is required.

5. The remote monitoring system according to claim 4,
wherein the information pertaining to the state of the lithium-ion secondary battery includes the voltage and/or resistance of the lithium-ion secondary battery,
wherein the data in the server storage unit includes correlation data between the state of charge and the voltage and/or resistance pertaining to the lithium-ion secondary battery, and
wherein the server determination unit determines that the action is required when the information pertaining to the state of the lithium-ion secondary battery is out of a normal range in comparison to the correlation data from the server storage unit.

6. The remote monitoring system according to claim 4,
wherein the information pertaining to the state of the lithium-ion secondary battery includes the voltage and/or resistance and the temperature of the lithium-ion secondary battery,
wherein the data in the server storage unit includes correlation data between the state of charge and the voltage and/or resistance pertaining to the lithium-ion secondary battery at various temperatures, and
wherein the server determination unit determines that the action is required when the information pertaining to the state of the lithium-ion secondary battery is out of a normal range in comparison to the correlation data from the server storage unit corresponding to the temperature.

7. The remote monitoring system according to claim 4, wherein the server storage unit accumulates the status information that the server reception unit receives, thereby enhancing the data necessary for determining normality and abnormality.

8. The remote monitoring system according to claim 1, wherein communication between the wireless communication module and the remote server is performed by Bluetooth Low Energy (BLE) or low-power wide-area (LPWA) communication.

9. The remote monitoring system according to claim 1, wherein the lithium-ion secondary battery is a secondary battery comprising a positive electrode plate which is a lithium composite oxide sintered plate, a negative electrode layer which is composed of a lithium titanate sintered plate or which contains carbon, a separator disposed between the positive electrode plate and the negative electrode layer, and an electrolyte.

10. The remote monitoring system according to claim 9, wherein the lithium composite oxide composing the positive electrode plate is lithium cobaltate.

11. The remote monitoring system according to claim 9, wherein the negative electrode layer is composed of a lithium titanate sintered plate.

12. The remote monitoring system according to claim 1, wherein the lithium-ion secondary battery is the chip-type ceramic secondary battery “EnerCera”®.

13. A maintenance method for a battery, the maintenance method comprising the steps of:
perceiving abnormality of the lithium-ion secondary battery through an alert appealing to the five senses via the remote monitoring system according to claim 1; and
taking measures for returning the lithium-ion secondary battery to a normal state.

14. The maintenance method for a battery according to claim 13,
wherein the status information includes information pertaining to the state of the lithium-ion secondary battery, and in the remote monitoring system, when charging, repair, or replacement of the lithium-ion secondary battery is determined to be necessary on the basis of the information, the warning signal is transmitted and received, and
wherein the measures for returning the lithium-ion secondary battery to the normal state include moving the lithium-ion secondary battery to a location where wireless power transfer is available and/or repairing or replacing the lithium-ion secondary battery.
